(19) United States
(12) Patent Application Publication
(10) Pub. No.: US 2026/0350905 A1
(43) Pub. Date: Nov. 5, 2026

(54) REAL-TIME PARAMETERIZATION OF IMPLICIT SURFACES

(71) Applicant: Adobe Inc., San Jose, CA (US)

(72) Inventors: Jérémy Nicolas Levallois, Lyon (FR); Stephanie Wang, San Jose, CA (US); Pierre Gueth, Lyon (FR); Baptiste Louis Henry Genest, Villeurbanne (FR)

(73) Assignee: Adobe Inc., San Jose, CA (US)

(21) Appl. No.: 19/194,760

(22) Filed: Apr. 30, 2025

(51) Int. Cl. G06T 15/04; G06T 7/73; G06T 15/00; G06T 17/20

(52) U.S. Cl. CPC G06T 15/04; G06T 7/75; G06T 15/005; G06T 17/20; G06T 2200/04

(57) ABSTRACT

In implementing real-time parameterization of implicit surfaces, a processing device receives an implicit surface representing a three-dimensional (3D) object. The processing device approximates a geodesic path between one or more query points and a reference point on the implicit surface. Using the geodesic path, the processing device generates a parameterization patch on the implicit surface. The parameterization patch provides a localized two-dimensional (2D) coordinate system on a portion of the 3D object's surface. UV coordinates are generated for the query point based on the geodesic path.

### BACKGROUND

A digital three-dimensional (3D) model is a computer-generated representation of an object that captures the object's shape, size, and appearance (e.g., color, texture). Implicit surfaces are widely used in computer graphics to represent and model objects with complex shapes. Instead of defining a surface by polygons (e.g., triangular meshes), implicit surfaces are defined by scalar fields in three-dimensional space, offering advantages such as smooth blending, easy topological changes, and potentially compact representations.

However, applying two-dimensional textures to implicit surfaces presents technical challenges due to their volumetric nature. Conventional texture mapping techniques use explicit surface representations like polygonal meshes, which utilize well-defined local UV coordinates for mapping two-dimensional (2D) textures onto 3D surfaces. These conventional techniques cannot be directly applied to implicit surfaces without first converting the implicit surfaces to explicit mesh representations, a process that is computationally expensive and eliminates many of the inherent advantages of implicit surfaces. As computer graphics applications increasingly utilize implicit surface representations for modeling, animation, and real-time rendering, applying 2D textures and details to implicit surfaces without sacrificing their topological flexibility remains challenging.

### SUMMARY

Techniques and systems for real-time parameterization of implicit surfaces are described. In one example, a processing device receives an implicit surface representing a 3D object and generates one or more parameterization patches on the implicit surface using a respective reference point. Each parameterization patch provides a localized 2D coordinate system on a portion of the 3D object's surface. The processing device then approximates a geodesic path between a query point and the reference point for each parameterization patch on the implicit surface. The geodesic path is approximated by projecting a gradient of Euclidean distance between the query point and the reference point onto a tangent plane of the implicit surface and moving along the surface using a second-order approximation. Based on the geodesic path, the processing device generates UV coordinates for the query point. The described techniques and systems enable efficient and accurate computation of UV coordinates on complex implicit surfaces.

In one implementation, the processing device generates multiple local parameterization patches on the implicit surface using multiple reference points and merges these patches into a larger, spatially coherent region. The merging involves assigning UV offsets, scales, and/or rotations to each reference point and blending the UV coordinates from adjacent parameterization patches using a weighting function based on geodesic distances. The resulting semi-global parameterization conforms to the geometry of the implicit surface, allowing for more consistent and continuous texture mapping across larger areas of the 3D object.

The described techniques enable modeling applications to apply texture maps to implicit surfaces using the generated UV coordinates. The texture maps can include color textures, normal maps, shell maps, or displacement maps, which enable rich visual detail to be added to 3D objects represented by implicit surfaces. In addition, the described techniques are designed to be performed in real-time, for example by shaders executing on a graphics processing unit. Accordingly, the parameterization can be dynamically updated in response to deformations or topological changes of the implicit surface, making them suitable for interactive applications and real-time rendering scenarios.

This Summary introduces a selection of concepts in a simplified form that are further described below in the Detailed Description. As such, this Summary is not intended to identify essential features of the claimed subject matter, nor is it intended to be used to determine the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

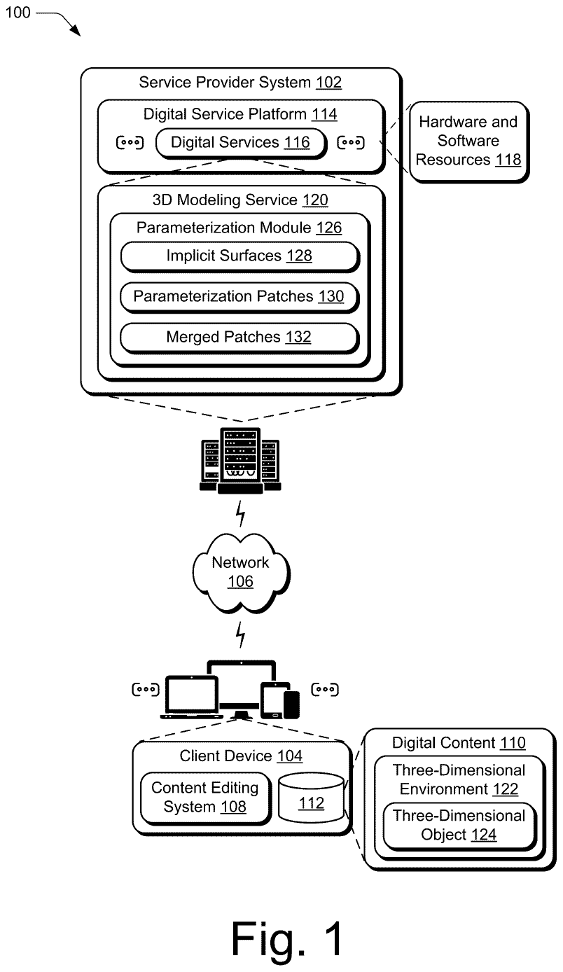

FIG. 1 is an illustration of a digital medium environment in an example implementation that is operable to employ techniques and systems for real-time parameterization of implicit surfaces as described herein.

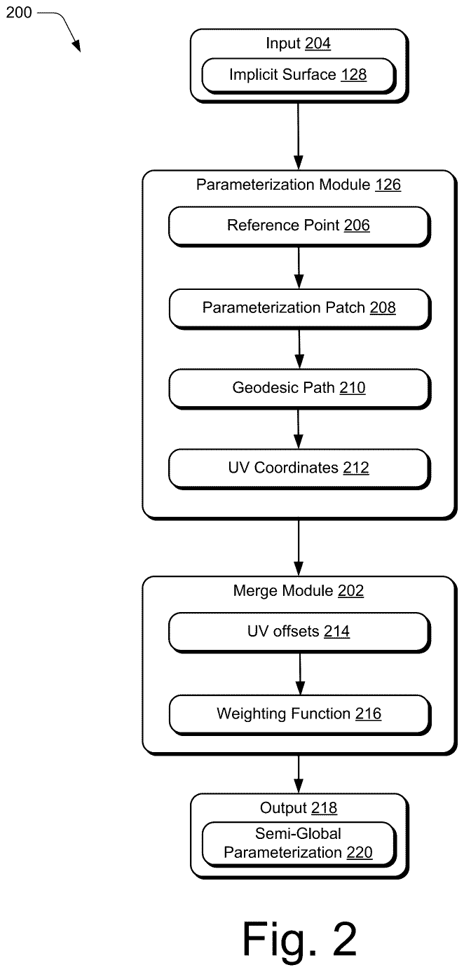

FIG. 2 depicts a system in an example implementation showing an operation of real-time parameterization of implicit surfaces.

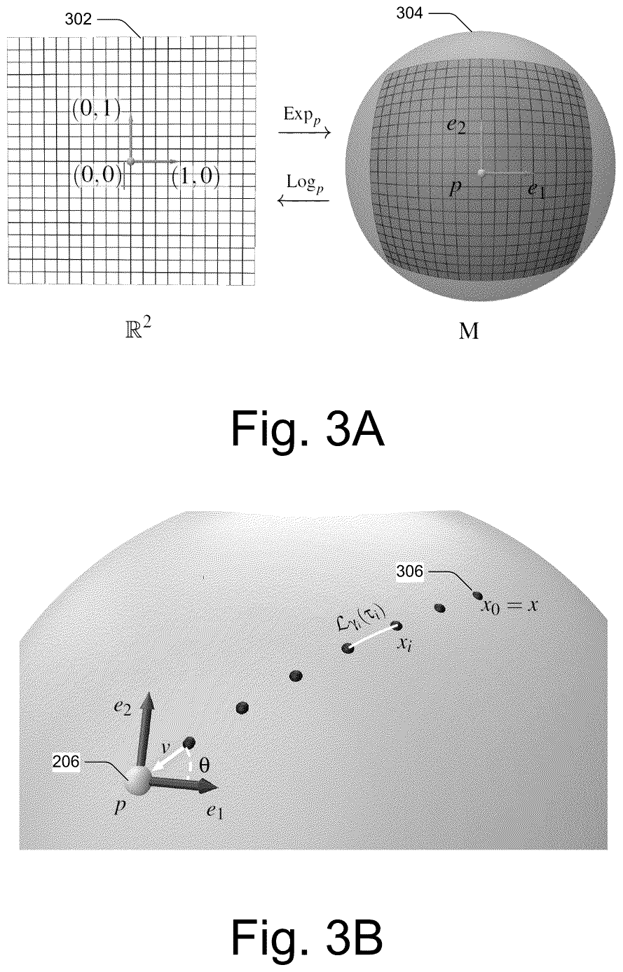

FIG. 3A illustrates an example log map generated by the parameterization module of FIGS. 1 and 2 from an exponential map of a surface.

FIG. 3B illustrates a process that the parameterization module of FIGS. 1 and 2 uses to estimate the geodesic path.

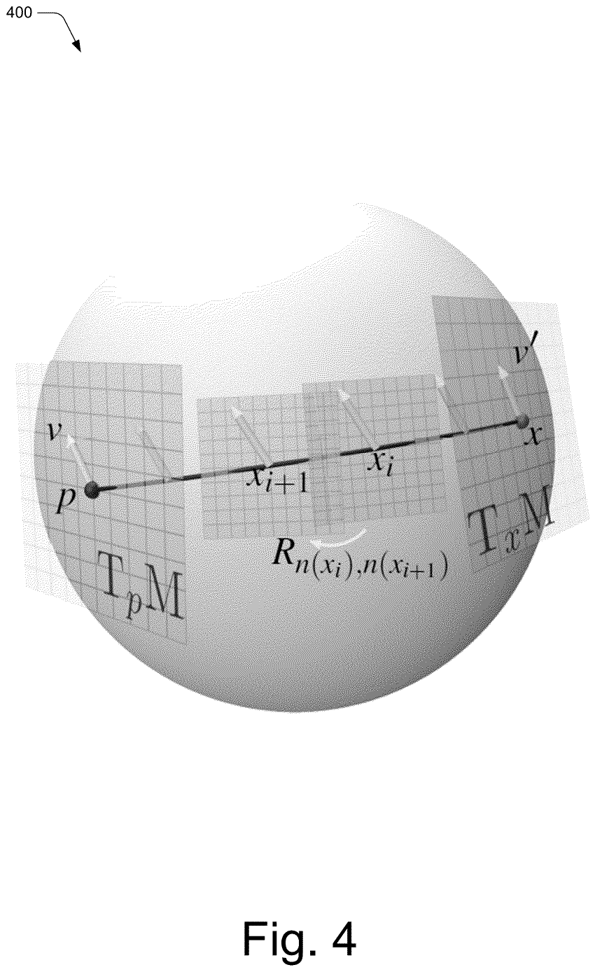

FIG. 4 illustrates the accumulation process of the parameterization module of FIGS. 1 and 2.

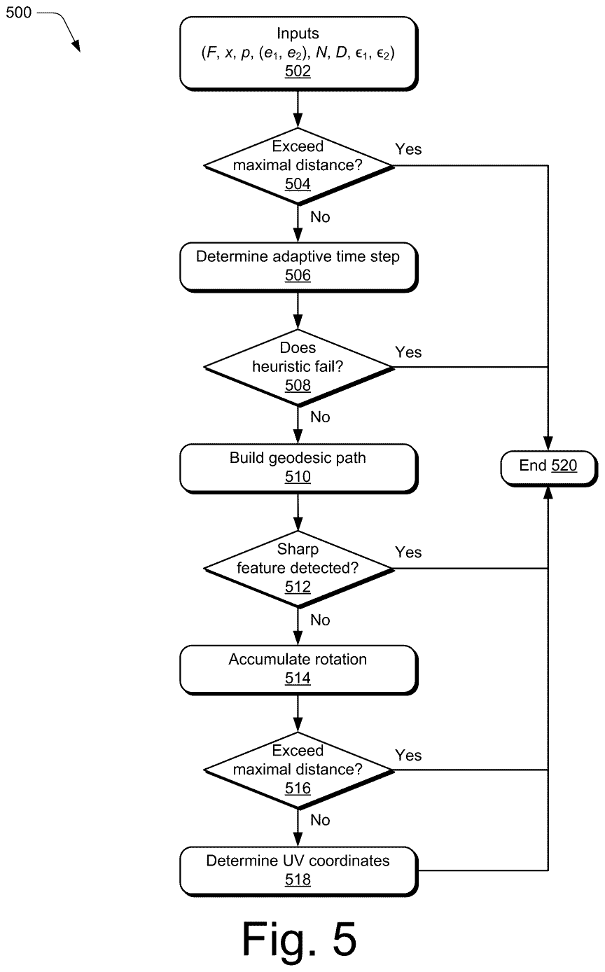

FIG. 5 depicts a procedure in an example implementation of generating a log map around a reference point.

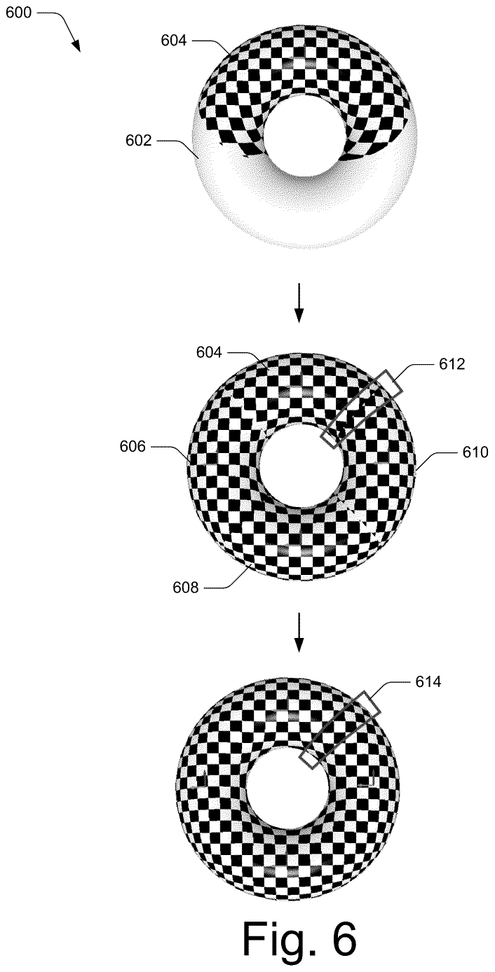

FIG. 6 depicts an example of generating and merging multiple parameterization patches on an implicit surface.

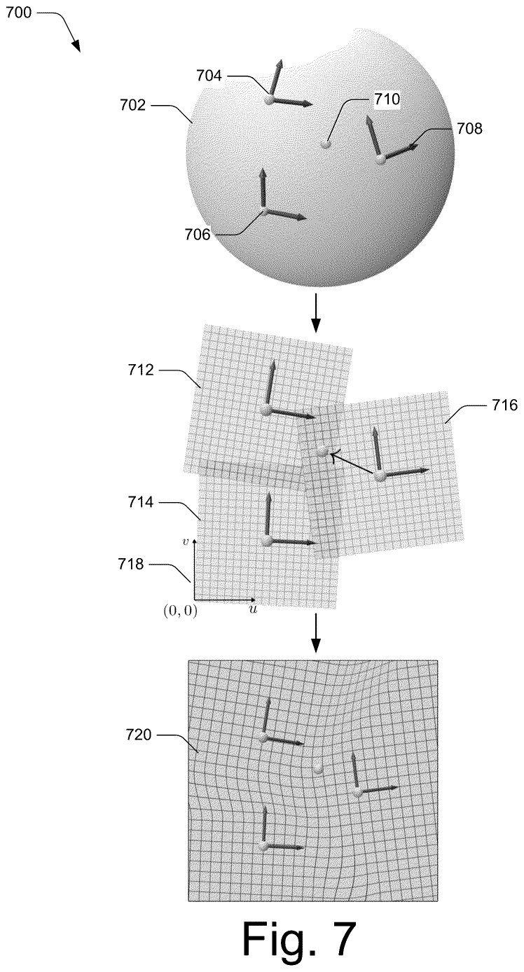

FIG. 7 depicts an example of combining multiple UV fields.

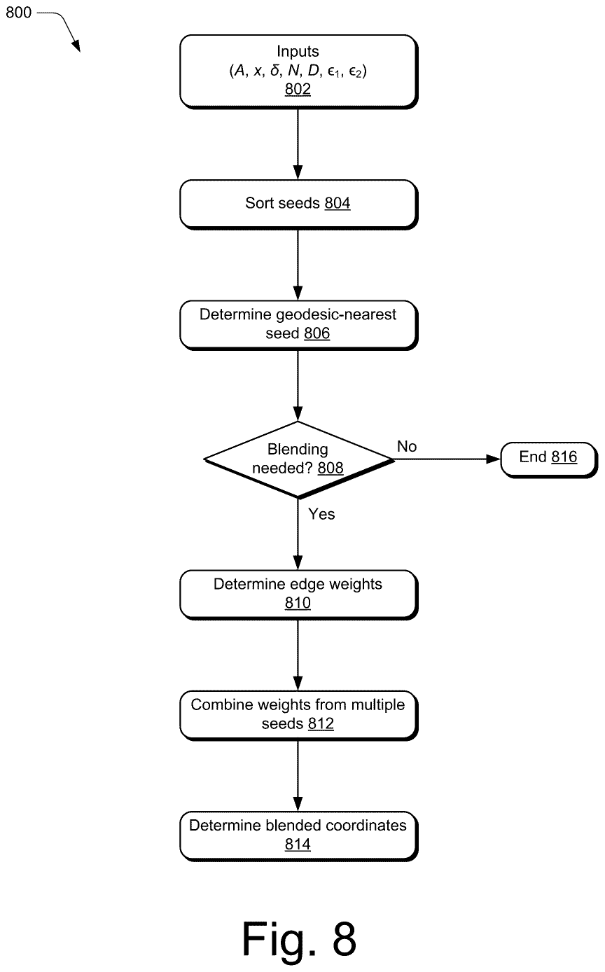

FIG. 8 depicts a procedure in an example implementation of generating blended UV coordinates.

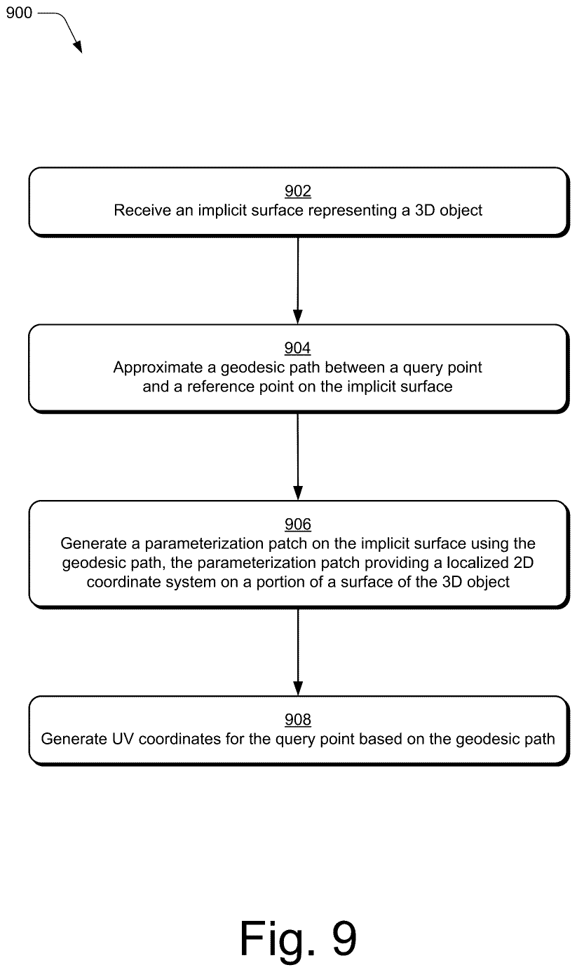

FIG. 9 depicts a procedure in an example implementation of real-time parameterization of implicit surfaces.

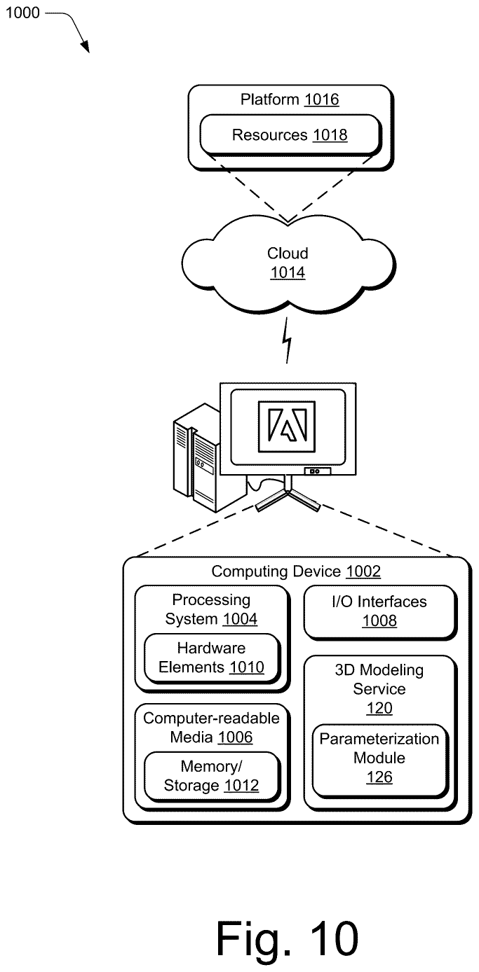

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Implicit surfaces are a common way to represent and model 3D objects digitally. Implicit surfaces generally represent objects using mathematical equations (e.g., closed-form equations), where points satisfying these equations lie on the surface, or by discretizing the scalar field in a dense grid. Instead of explicitly defining vertices and faces (e.g., as with triangular meshes), implicit surfaces are defined by scalar fields in 3D space. Using implicit surfaces, modeling applications can create complex and organic shapes that would be difficult to model using conventional polygonal techniques. For example, implicit surfaces allow for smooth blending between shapes, easy topological modifications, and compact representations. This representation approach enables more flexible and robust manipulation of 3D geometries. However, applying 2D textures to implicit surfaces presents significant technical challenges due to their volumetric nature.

Conventional texture mapping techniques use explicit surface representations with well-defined UV coordinates for mapping 2D textures onto 3D surfaces. These techniques cannot be directly applied to implicit surfaces without first converting the implicit surfaces to explicit mesh representations, a process that is computationally expensive and eliminates many inherent advantages of implicit surfaces. As computer graphics applications increasingly utilize implicit surface representations for modeling, animation, and real-time rendering, efficiently applying 2D textures and surface details to implicit surfaces while preserving their topological flexibility remains a significant technical challenge.

Existing approaches to texturing implicit surfaces often involve global parameterization methods or conversion to explicit representations (e.g., into a mesh via marching cubes or dual contouring techniques). Meshing is computationally expensive, limiting its use in real-time applications, and can introduce unwanted feature smoothing and discretization artifacts. Additionally, the meshing process negates the advantages of using implicit surfaces for real-time modeling if the modeling application first generates the mesh to add surface details.

Other conventional approaches attempt to compute coordinates or add texture details on implicit surfaces without discretizing the surface. These conventional techniques, however, make restrictive assumptions about the surface-defining equation. For example, some techniques use structured fields (e.g., using simple shapes or a series of simple shapes structured in a specific manner) to compute coordinates and blend textures, add fine geometric details on the surface from noise defined on the surface, or apply displacement maps on shapes with canonical coordinates. Because the shapes are described using a large set of points, such approaches tend to be computationally intensive in terms of sampling, encoding complex geometries, and storing coordinates at each seed point. As a result, these conventional techniques can introduce distortions or artifacts in the resulting texture mapping, particularly for complex shapes with intricate surface details.

To address these limitations, the described techniques for real-time parameterization of implicit surfaces provide an efficient and point-wise approach to generate semi-global UV coordinates while avoiding meshing. The described techniques enable the generation of point-wise and parallelizable parameterizations for texturing, rendering, and modeling purposes. By computing local parameterization patches and enabling the merging of multiple adjacent patches into larger, spatially coherent regions that conform to the underlying geometry, the described techniques provide a flexible and efficient solution for texturing implicit surfaces.

The described techniques utilize a sphere-tracing pipeline implemented in shaders, allowing users to edit UV fields with real-time visualization. An example modeling application leverages the generated parameterization to enable users to add rendering details such as color textures, normal maps, shell maps, and displacement maps. The textured objects remain implicit and can still be used in a modeling pipeline, preserving the advantages of implicit surface representations for real-time operations.

In one implementation, a real-time parameterization module builds local parameterizations and enables the joining of multiple adjacent parameterized patches into a common coordinate system by moving along the surface using a second-order approximation of the shape. The real-time parameterization module constructs a point-wise and parallelizable local parameterization of the surface from an approximation of the geodesic path between query and reference points. Each parameterization patch is defined on a smooth region delimited by sharp features. Blending multiple local parameterization patches into a common coordinate system allows a larger portion of the surface to be parameterized while maintaining geometric continuity.

In this way, the described real-time parameterization module enables users to apply textures of color, normal heights, and displacement maps in a sphere-tracing rendering pipeline without sacrificing the benefits of implicit surface representations. The described module can also encode complex shapes as displacements on simple implicit surfaces, separating base geometry from fine details. In addition, evaluations of the generated parameterizations can run in parallel and be efficiently implemented on a graphics processing unit (GPU) to enable real-time performance for interactive applications.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Example Environment

FIG. 1 is an illustration of a digital medium environment 100 in an example implementation that is operable to employ techniques and systems for real-time parameterization of implicit surfaces as described herein. The illustrated environment 100 includes a service provider system 102 and a client device 104 that are communicatively coupled, one to another, via a network 106. Computing devices that implement the service provider system 102 and the client device 104 are configurable in various ways.

A computing device, for instance, is configurable as a desktop computer, a laptop computer, a mobile device (e.g., assuming a handheld configuration such as a tablet or mobile phone as illustrated), and so forth. Thus, a computing device ranges from a full-resource device with substantial memory and processor resources (e.g., personal computers and game consoles) to a low-resource device with limited memory and/or processing resources (e.g., some mobile devices). Additionally, although a single computing device is shown and described in some examples, a computing device is also representative of a plurality of different devices, such as multiple servers utilized by a business to perform operations “over the cloud,” as described in FIG. 10.

The client device 104 is illustrated as including a content editing system 108. The content editing system 108 is implemented at least partially in the hardware of the client device 104 to process and transform digital content 110, which is illustrated as maintained in a storage device 112 of the client device 104. Such processing includes creating the digital content 110, modifying the digital content 110, and rendering the digital content 110 in a user interface for output, e.g., by a display device.

The service provider system 102 is illustrated in this example as implementing a digital service platform 114 to provide digital services 116 through execution of hardware and software resources 118. The digital services 116 are representative of functionality made available by the service provider system 102 via the network 106 to the client device 104. In a first instance, the digital services 116 include a social network service that is executable to share communications, posts, digital content, and so forth. In a second instance, the one or more digital services 116 include a stock digital service configured to provide access to digital content (e.g., for a fee) that is located using a digital search service.

In the illustrated instance, the digital services 116 include a three-dimensional (3D) modeling service 120. In this example, the 3D modeling service 120 is configured to operate in conjunction with the content editing system 108 to support functionality to edit (e.g., create) a 3D environment 122 and a 3D object 124 disposed within the three-dimensional environment 122. Although illustrated as implemented at the service provider system 102 as one of the digital services 116, this functionality may also be implemented locally at the client device 104, e.g., solely by the content editing system 108.

The modeling service 120 supports various functionalities configured to support and implement editing of the 3D environment 122 and the 3D object 124. Examples of which to do so are represented as a parameterization module 126 that represents the 3D environment 122 and/or the 3D object 124 using implicit surfaces 128. As described in greater detail below, the parameterization module 126 generates one or more local parameterization patches 130 of the implicit surfaces 128 and one or more merged patches 132 of the local parameterization patches 130 to allow users to edit UV fields with real-time visualization and add rendering details (e.g., texture, normal heights, and displacement heights) using the parameterizations.

Implicit surfaces 128 are a common way to represent shapes digitally. Implicit representations encode the surface M as a subset of embeddings in 3D space (e.g., M⊂ [symbol] ), which is defined as the set of zeros of a scalar field ƒ: [symbol] → [symbol] , such that:

M={x∈ [symbol] |ƒ(x)=0}. (1)

While M can include volumetric regions (3D), curves (1D), or isolated points (0D, M is generally a surface (2D). The scalar field ƒ allows the 3D modeling service 120 or the parameterization module 126 to query the location of the surface M. If, additionally, ƒ satisfies the Eikonal equation, ∥∇ƒ|≡1, then ƒ becomes a signed distance field (SDF), meaning that there exists a volumetric region Ω where ∂Ω=ƒ⁻¹(0) and

$$f ( x ) = \{ \begin{matrix}- d ( x , \partial Ω ) , & if x ∈ Ω , \\ d ( x , \partial Ω ) , & else .\end{matrix} \qquad ( 2 )$$

When a surface M is encoded with an SDF ƒ, sphere tracing by the parameterization module 126 computes the intersection of a ray and the surface by iterating xₖ₊₁=xₖ+ƒ(xₖ) [symbol] , where [symbol] is the direction of the ray and ƒ(xₖ)=d(xₖ,M) is the largest “safe” (e.g., not intersecting with M) step size. If ƒ is calculable in parallel, a GPU implementation in the shader language of the iterative equation can significantly speed up ray tracing to achieve real-time rendering. The 3D modeling service 120 employs this sphere tracing technique for rendering implicit surfaces 128 because it enables 3D geometry editing in a fully implicit setting with real-time visualization.

The described techniques devise a fast and point-wise approach to generate semi-global UV coordinates on implicit surfaces 128 for texturing purposes while avoiding meshing. By moving along the surface M using a second-order approximation of the shape, the described techniques build local parameterization patches 130 and provide a way to join multiple adjacent parameterized patches together into a common coordinate system and merged patches 132. Built into a sphere-tracing renderer of the 3D modeling service 120, the described techniques run in real-time on analytic SDFs, allowing users to edit the UV fields with instantaneous feedback. Because the implicit surface 128 is not meshed, the final textured object remains implicit and can be used in a modeling pipeline, for example, to perform topological operations on the shape in real-time, deform it, or exploit symmetries.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Environment

FIG. 2 depicts a system 200 in an example implementation showing an operation of real-time parameterization of implicit surfaces. The system 200 generates semi-global parameterizations of 3D objects represented by implicit surfaces. The system 200 includes several interconnected components, including a parameterization module 126 and a merge module 202, that work together to process implicit surfaces and produce parameterizations for various computer graphics and modeling applications.

The system 200 provides increased capabilities compared to conventional techniques when rendering implicit surfaces using sphere tracing. In sphere-tracing pipelines, the GPU computes, in parallel, the intersection between its ray and the surface for each pixel of the screen. For each ray-surface intersection x∈M, the system 200 queries additional rendering textures or attributes [symbol] (u,v) (e.g., color, specularity, etc.). The system 200 uses a point-wise approach to derive UV coordinates, which is implementable in a GPU renderer.

The parameterization module 126 generates local parameterizations on the surface. For example, the parameterization module 126 creates parameterization patches that provide localized two-dimensional (2D) coordinate systems on portions of the 3D object's surface. The parameterization module 126 may utilize various mathematical techniques to generate the local parameterizations, such as exponential maps. The parameterization module 126 is implemented in hardware and/or software, employing adaptive algorithms that adjust the size and shape of the parameterization patches based on local surface features, curvature, or user-defined criteria. In some implementations, the parameterization module 126 incorporates parallel processing capabilities, leveraging GPU acceleration to compute multiple parameterization patches simultaneously for improved performance. Additionally, the parameterization module 126 can include mechanisms for detecting and handling singularities or areas of high geometric complexity on the implicit surface, ensuring robust parameterization even for challenging surface topologies.

The merge module 202 is implemented in hardware and/or software to create a more cohesive parameterization across the surface of 3D objects. The merge module 202 combines adjacent parameterization patches into larger, spatially coherent regions conforming to the geometry of the implicit surface 128. For example, the merge module 202 uses various blending techniques to seamlessly join adjacent parameterization patches, such as weighted averaging, radial basis functions, or partition of unity methods. In some implementations, the merge module 202 merges patches at multiple scales to create a multi-resolution parameterization that can adapt to different levels of detail across the surface. As described below, the merge module 202 can also incorporate feature-aware algorithms to preserve specific geometric characteristics, such as sharp edges or high-curvature regions, during the merging process. The merging process also includes mechanisms for detecting and resolving conflicts or inconsistencies between adjacent patches, ensuring a smooth and continuous parameterization across patch boundaries.

To begin, the parameterization module 126 receives an input 204, including an implicit surface 128 representing a 3D object. The implicit surface 128 is generally defined by a scalar field in 3D space, where the surface is expressed as the zero-level set of this field. This representation allows for complex geometries and topologies to be described efficiently.

The parameterization module 126 begins by selecting a reference point 206 on the implicit surface 128. This reference point 206, p & M, serves as an anchor or seed for generating a parameterization patch 208. The parameterization patch 208 is a local region of the surface where a 2D coordinate system is established, allowing for efficient mapping of textures and other surface properties. The local parameterization patch 208 is a mapping from a neighborhood U of p to [symbol] :

φₚ:U⊂M→

[symbol]

x [symbol] (u,v) (3)

To create the parameterization patch 208, the parameterization module 126 approximates a geodesic path 210 between the reference point 206 and other points (e.g., query points x) on the surface within the patch. The parameterization module 126 uses an approximation of the exponential map and an ambient heuristic to approximate the geodesic path 210 between the query point x and the reference point p. Geodesics are the generalization of straight lines to a (curved) manifold. A curve γ:[0,T]→M is a geodesic if it is a critical point of the following energy:

$$E ( γ ) = {\int }_{0}^{T} {‖ \dot{γ} ( t ) ‖}^{2} dt \qquad ( 4 )$$

where ∥⋅∥ is the standard Euclidean norm in [symbol] . Such a curve is parameterized by arc length, e.g., ∥\dot{γ}∥≡1. Geodesics are the locally shortest paths on a surface. A geodesic path 210 beginning with point p∈M with an initial direction v∈TₚM is the critical point of E(γ) with the following initial values:

$$\{ \begin{matrix}{γ}_{p}^{v} ( 0 ) = p \\ {\dot{γ}}_{p}^{v} ( 0 ) = \frac{v}{‖ v ‖}\end{matrix} . \qquad ( 5 )$$

The exponential map Expₚ(v):TₚM→M maps any vector v to the solution of Equation (5) at t=∥v∥:

$${Exp}_{p} ( v ) = {γ}_{p}^{v} ( ‖ v ‖ ) . \qquad ( 6 )$$

From the arc length parameterization, the geodesic distance between p and Expₚ(v) is d_{M}(p,Expₚ(v)=∥v∥.

The geodesic path 210 is computed using a second-order approximation of the surface geometry, which provides a balance between accuracy and computational efficiency. In other implementations, a first-order approximation is used; however, the second order approximation permits larger steps and, therefore, fewer evaluations to move a fixed distance T, even on irregular surfaces. The second-order approximation accounts for the local curvature of the surface, ensuring that the resulting parameterization conforms to the underlying geometry.

A second-order approximation of the exponential map on an implicit surface 128 M is a path

$$f ( {γ}_{p}^{v} ( τ ) ) = o ( {τ}^{2} ) . \qquad ( 7 )$$

such that:

$${S}_{p} : {T}_{p} M \to {T}_{p} M \qquad ( 8 )$$

$$v ↦ {D}_{v} n ( p ) = \frac{\partial n}{\partial v} {\vert}_{p} .$$

To build such

$${γ}_{p}^{v} ,$$

the parameterization module 126 uses second-order geometric quantities of M. Let n:M→ [symbol] denote the Gauss map of

$$n ( p ) = \frac{∇ f ( p )}{‖ ∇ f ( p ) ‖} .$$

The shape operator at p is defined as the differential of n,

$${S}_{p} : {T}_{p} M \to {T}_{p} M v ↦ {D}_{v} n ( p ) = \frac{\partial n}{\partial v} {\vert}_{p} . \qquad ( 8 )$$

The eigenvalues κ₁, κ₂ and eigenvectors v₁, v₂ of Sₚ are the principal curvatures and principal curvature directions of M at p. For implicit surfaces, the parameterization module 126 computes the shape operator Sₚ from ƒ with:

$${S}_{p} = ( I - n ( p ) {n ( p )}^{T} ) \frac{{H}_{f} ( p )}{‖ ∇ f ( p ) ‖} , \qquad ( 9 )$$

where H_{ƒ}(p) denotes the Hessian of ƒ at p. The shape operator gives a local quadratic approximation of the surface M,

$${γ}_{p}^{v} ( τ ) = p + τ v + \frac{{τ}^{2}}{2} 〈 v , {S}_{p} ( v ) 〉 n ( p ) = p + τ v + \frac{{τ}^{2}}{2 ‖ ∇ f ( p ) ‖} 〈 v , {H}_{f} ( p ) v 〉 n ( p ) . \qquad ( 10 )$$

Evaluating the full Hessian in Equation 10 is computationally expensive (e.g., using finite difference, ƒ is evaluated 18 times). The parameterization module 126 can use just the term [symbol] v,H_{ƒv} [symbol] =(Dᵥ)²ƒ. The three-point finite difference scheme,

$$〈 v , {H}_{f} v 〉 = {( {D}_{v} )}^{2} f = \frac{f ( p - h v ) - 2 f ( p ) + f ( p + h v )}{{h}^{2}} + o ( {h}^{2} ) , \qquad ( 11 )$$

uses two additional evaluations of ƒ since ƒ(p) is used. For highly curved surfaces or those differentiable but not twice differentiable, the parameterization module 126 can re-project the approximation of Expₚ(v) onto M using:

$${\prod }_{f} ( x ) = x - f ( x ) \frac{∇ f ( x )}{{‖ ∇ f ( x ) ‖}^{2}} . \qquad ( 12 )$$

The exponential map Expₚ maps the tangent plane TₚM to the surface M. If an orthonormal basis e₁, e₂∈TₚM is selected, then the parameterization module 126 can map [symbol] to M by:

[symbol]

→M

(u,v) [symbol] Expₚ(ue₁+ve₂). (13)

Given a 2D coordinate system (u,v), the parameterization module 126 uses Equation 13 to deduce the 3D point location Expₚ(ue₁+ve₂) on M. This process describes the inverse of the goal expressed in Equation 3. The parameterization module 126 builds the inverse of the exponential map, the logarithmic (e.g., log) map, which is defined locally on a neighborhood U⊂M near p:

Logₚ:U→TₚM, (14)

such that Expₚ(Logₚ(x))=x.

FIG. 3A illustrates an example log map 302 generated by the parameterization module 126 of FIGS. 1 and 2 from an exponential map 304 of a surface. As illustrated in FIG. 3A, using the same parameterization of TₚM→ [symbol] for the fixed orthonormal frame e₁, e₂∈TₚM, the log map 302 effectively maps U to [symbol] . With a selected fixed orthonormal frame e₁, e₂∈TₚM, the exponential map 304 Expₚ maps a flat plane to the surface, while the log map 302 Logₚ provides each nearby point x with 2D coordinates.

Computing the inverse map is more complex than the forward map. The log map 302 takes a query point x∈M and finds the velocity v=\dot{γ}(0)∈TₚM of the geodesic γ from p=γ(0) to x=γ(T). The parameterization module 126 solves the optimization problem with fixed boundary values:

$${min}_{γ ( 0 ) = p , γ ( T ) = x} E ( γ ) . \qquad ( 15 )$$

Large-scale approaches to computing geodesics often use global approaches to simultaneously explore large portions of the geometry. However, the parameterization module 126 avoids meshing the surface and runs the queries in parallel, so the parameterization module 126 resorts to locally approximating the geodesic for each query point x.

In a fashion similar to the A-star (e.g., A*) search algorithm, the parameterization module 126 follows a heuristic to guide the path. The geodesic path 210 is approximated from x to p with a gradient flow of the Euclidean ambient distance d(y,z)=∥y−z∥ while adhering to the surface M:

$$\{ \begin{matrix}\dot{γ} ( t ) = {\prod }_{{T}_{γ ( t )} M} ( ∇ d ( γ ( t ) , p ) ) \\ γ ( 0 ) = x\end{matrix} \qquad ( 16 )$$

The gradient of Euclidean distance ∇d has a closed form,

$$∇ d ( γ ( t ) , p ) = \frac{γ ( t ) - p}{‖ γ ( t ) - p ‖} . \qquad ( 17 )$$

So does the projection operator Π_{T}_{_{γ(t)}}_{M} on the tangent plane T_{γ(t)}M,

Π_{T}_{_{γ(t)}}_{M}=I₃−n(γ(t)n(γ(t))^{T}. (18)

The parameterization module 126 uses the exponential map defined in Equation 10 to keep the discretized sequence on the surface:

$${x}_{i + 1} = {Exp}_{{x}_{i}} ( - {τ}_{i} {∇}_{{x}_{i}}^{M} d ( {x}_{i} , p ) ) . \qquad ( 19 )$$

Here τᵢ denotes the step size at step i. The parameterization module 126 uses a local geodesic tracing technique to approximate the geodesic between two points to avoid the dichotomy between the initial value problem and the boundary value problem.

Based on the geodesic path 210, the parameterization module 126 generates UV coordinates 212 for points within the parameterization patch 208. The UV coordinates 212 form the basis of the 2D coordinate system on the surface, allowing for the mapping of textures and other 2D data onto the 3D object.

Although the curve γ cannot be directly converted to UV coordinates in TₚM, the parameterization module 126 utilizes the conversion of polar to Cartesian coordinates:

(u,v)=r(cos(θ),sin(θ)). (20)

The parameterization module 126 estimates the length r= [symbol] (γ) and an angle θ between the direction of y at its endpoint p and the fixed frame e₁, e₂∈TₚM.

FIG. 3B illustrates a process that the parameterization module 126 of FIGS. 1 and 2 uses to estimate the geodesic path 210. Following a gradient descent of the Euclidean distance while adhering to the surface yields an approximated geodesic path 210 between a query point 306 x and the reference point 206 p. The parameterization module 126 calculates the coordinates from the arc length of the curve and its incoming angle at endpoint p with a fixed frame fixed frame e₁, e₂.

For example, the parameterization module 126 computes [symbol] (γ) by measuring each of the N curves γᵢ, joining xᵢ=γᵢ(0) and xᵢ₊₁=γᵢ(τᵢ) from Equation 19:

$$ℒ ( γ ) \approx {\sum }_{i = 0}^{N - 1} ℒ ( {γ}_{i} ) . \qquad ( 21 )$$

The parameterization module 126 then approximates each [symbol] (γᵢ) using Simpson's rule:

$$ℒ ( γ ) = {\int }_{0}^{τ} ‖ \dot{γ} ( s ) ‖ ds \approx \frac{τ}{6} ( ‖ \dot{γ} ( 0 ) ‖ + ‖ \dot{γ} ( \frac{τ}{2} ) ‖ + ‖ \dot{γ} ( τ ) ‖ ) . \qquad ( 22 )$$

To estimate the incoming angle θ at p, the parameterization module 126 first calculates it's unit tangent direction at the endpoint p=γ(T):

$$v = \frac{\dot{γ} ( T )}{‖ \dot{γ} ( T ) ‖} . \qquad ( 23 )$$

Because the frame e₁, e₂∈TₚM is orthonormal, the parameterization module 126 computes the log map in UV coordinates using:

$${Log}_{p}^{uv} ( x ) = ℒ ( γ ) ( 〈 - v , {e}_{1} 〉 , 〈 - v , {e}_{2} 〉 ) . \qquad ( 24 )$$

The curve-based parameterization by the parameterization module 126 has several advantages compared to conventional techniques using direct estimators for implicit decals. Since the parameterization module 126 walks on the surface, it generates a better estimation of the geodesic distances and can accumulate additional geometric information along the curve as explained in reference to FIG. 5.

FIG. 5 depicts a procedure 500 in an example implementation of generating a log map around a reference point. To begin, the parameterization module 126 receives inputs (block 502). The inputs include an implicit-surface scalar field function F, a query point x∈M, a reference point p, a parameterization frame (e₁,e₂), a maximum number of iterations N, a maximum distance D, and tolerance parameters (ϵ₁,ϵ₂).

The parameterization module 126 determines whether a maximal distance D is exceeded (block 504). If the maximal distance is not exceeded (e.g., a “no” determination at block 504), the parameterization module 126 determines an adaptive time step (block 506). The adaptive time step allows the system to adjust the size and shape of each local parameterization patch based on the local surface curvature of the implicit surface. The adaptive approach enables more efficient computation in areas of high curvature while maintaining accuracy.

To ensure the continuity of the local parameterization, procedure 500 includes the same number of steps at each query point. Consider that x and x′ are two nearby query points. Because the parameterization module 126 runs procedure 500 on x and x′ independently, if the parameterization module 126 uses N steps in one situation and N−1 steps for the other, that missing step can introduce discontinuities in their UV coordinates. Using a fixed number of iterations with adaptive step size helps evenly allocate computation time for each processing component of the parallel computation.

To utilize each iteration of the N steps, the parameterization module 126 selects the step size τᵢ of the gradient descent to maximize chances of obtaining an almost-geodesic curve y that reaches the reference point p. If the step size is too large, the parameterization module 126 can deviate from the level set M if it is highly curved; if it is too small, the parameterization module 126 might not reach the seed before the iterations run out. The time steps are set so that each iteration moves by the Euclidean distance between the current location and the goal ∥xᵢ−p∥, divided by the remaining number of steps:

$${s}_{i} := ‖ {x}_{i + 1} - {x}_{i} ‖ = \frac{‖ {x}_{i} - p ‖}{N - i} \qquad ( 25 )$$

To infer the step size for the above equation, the parameterization module 126 uses Equation 10 in which

$${x}_{i + 1} = {γ}_{i} ( {τ}_{i} ) = {x}_{i} + {τ}_{i} ν + \frac{{τ}_{i}^{2}}{2}$$

αn for some scalar α∈ [symbol] and ∥v∥=∥n∥=1, v⊥n. The parameterization module 126 then solves

$${‖ {γ}_{i} ( {τ}_{i} ) - {x}_{i} ‖}^{2} = {s}_{i}^{2}$$

for τᵢ:

$${τ}_{i} = \sqrt{\frac{\sqrt{1 + {s}_{i}^{2} {α}^{2}} - 1}{{α}^{2} / 2}} \leq {s}_{i} . \qquad ( 26 )$$

When the surface is flat, H_{ƒ}=0 and therefore α=0, the parameterization module 126 recovers τᵢ=sᵢ. When the surface M is smooth, the fact that each query point takes the same number of steps with position-dependent step size makes the resulting log map depend continuously on the input. When the surface is differentiable but not twice-differentiable, the parameterization module 126 can reproject xᵢ using Equation 12.

The parameterization module 126 computes the direction vᵢ:

$${υ}_{i} = {\prod }_{{n}_{{x}_{i}}^{⊥}} ( p - {x}_{i} ) \qquad ( 27 )$$

The parameterization module 126 then tests whether a heuristic fails by determining whether ∥vᵢ∥<ϵ₁ (block 508). The gradient flow of the Euclidean distance may not produce a valid curve between the query point x and the reference point p on the surface. Because the parameterization module 126 does not perform a global search to find the optimal path, procedure 500 might get stuck in a local minimum. Local minima are the points x such that p−x is co-linear with n(x). However, because the function x [symbol] d(x,p) is a continuous function on M with a global minimizer p, each point in the attraction basin of p should follow the gradient flow and reach p.

If the heuristic does not fail (e.g., a “no” determination at block 508), the parameterization module 126 builds a geodesic path using Equation 10 (block 510). The geodesic path approximates the shortest distance between the query point and the reference point on the implicit surface within the parameterization patch.

The parameterization module 126 then proceeds to determine whether a sharp feature is present (block 512). Sharp features are detected by testing for normal discontinuities along the geodesic path. A normal discontinuity is determined by comparing adjacent normal vectors and determining when an angle between the adjacent normal vectors exceeds a predefined threshold value. This detection allows the parameterization patch to be at least partially bounded by one or more sharp features, preserving geometric characteristics of the implicit surface.

Models often include sharp features where the normal is discontinuous, e.g., the 90-degree edges of a box. A geodesic tracer is unstable near sharp edges and corners because there is not a well-defined tangent plane to project the distance gradient, hence, the UV patch cannot cross them in a robust way. In the context of 3D design, sharp features often divide the shape into semantically separate regions, each having their own UV island. In some scenarios, sharp features signal different components made of different materials.

Since the described parameterization is based on geodesics connecting query points x and a reference point p, the parameterization module 126 can detect sharp features by testing for normal discontinuity along the curve:

n(xᵢ)·n(xᵢ₊₁)<1−ϵ₂ (28)

ϵ₂>0 and is the tolerance to normal changes. Because the test can provide false positives (e.g., detecting sharp features if the shape smoothly but rapidly curves), the parameterization module 126 can use different tolerance parameters at different regions to accommodate the geometry.

If a sharp feature is not detected (e.g., a “no” determination at block 512), the parameterization module 126 accumulates rotation along the geodesic path (block 514).

The parameterization module 126 proceeds to determine whether a maximal distance is exceeded by considering if rᵢ₊₁+d(xᵢ₊₁,p)>D, where rᵢ₊₁=rᵢ+ [symbol] _{γ}_{ᵢ}(τᵢ) (block 516). If the maximal distance is not exceeded (e.g., a “no” determination at block 516, the parameterization module 126 determines UV coordinates (block 518). The UV coordinates provide a two-dimensional representation of the position on the implicit surface, which can be used for texture mapping and other surface operations.

After block 518 or if any of the previous decisions were answered in the affirmative (e.g., a “yes” determination at block 504, 508, 512, or 512), the procedure 500 proceeds to end (block 520).

The procedure 500 is designed to be executed in real-time, allowing for dynamic updates of the local parameterization patches in response to deformations or topological changes of the implicit surface. This real-time capability enables interactive applications and efficient processing of evolving implicit surfaces.

Continuing with system 200 of FIG. 2, the parameterization module 126 can generate multiple local parameterization patches 208 on the implicit surface 128 using multiple reference points 206. The tuple of the reference point 206 and orthonormal frame (p,e₁,e₂)∈M×TₚM² is referred to as a seed for each parameterization patch 208. Multiple parameterization patches 208 enable comprehensive coverage of complex surfaces, especially where a single global parameterization is difficult to achieve.

The merge module 202 combines and blends multiple seeds together to reduce distortion and cover a greater area of the implicit surface 128. The blending of multiple seeds includes finding a geodesic-nearest seed, determining UV offsets 214 for each reference point to align the parameterization patches 208, and applying a weighting function 216 to blend the UV coordinates from adjacent patches. In other implementations, the reference points are also scaled and/or rotated to align the parameterization patches 208.

FIG. 6 depicts an example 600 of generating and merging multiple parameterization patches on an implicit surface 602. Because a single seed (e.g., a first seed 604) is often insufficient to parameterize a large area of the implicit surface 602 and distortion will accumulate away from the seed due to surface curvature, the system 200 can place multiple seeds (e.g., a second seed 606, a third seed 608, and a fourth seed 610) to cover a greater area of the implicit surface 602. The placement or generation of multiple seeds, however, creates discontinuity (e.g., a first discontinuity 612) between each of the parameterization patches. The merge module 202 uses the geodesic information between seeds to merge the patches and generate a semi-global parameterization without discontinuity (e.g., as reflected by no texture discontinuity in the box 614).

FIG. 8 depicts a procedure 800 in an example implementation of generating blended UV coordinates as performed by the merge module 202. To begin, the merge module 202 receives inputs (block 802). The inputs include an atlas A (e.g., A=({(pᵢ,e₁ᵢ,e₂ᵢ)}ᵢ,E), a query point x∈M, a bandwidth σ>0, a maximum number of iterations N, a maximum distance D, and tolerance parameters (ϵ₁,ϵ₂).

The merge module 202 sorts the nearby seeds (block 804). The seeds in the atlas A are arranged based on their geodesic distance to a query point x. The sorting facilitates efficient processing in subsequent steps of procedure 800 by prioritizing seeds that are more likely to influence the final blended parameterization.

If there are n seeds

$${\{ ( {p}_{i} , {e}_{1 i} , {e}_{2 i} ) \}}_{i = 1}^{n} ,$$

a query point x can move towards any of the n seeds to obtain its UV coordinates. Following the sorting, the merge module 202 determines the geodesic-nearest seed (block 806). For example, the merge module 202 identifies the seed that is closest to the query point x in terms of geodesic distance on the implicit surface. The geodesic-nearest seed serves as a reference for the blending process.

Conventional techniques use the seed closest to the query point measured by the Euclidean distance, but these strategies can incur significant errors because a small Euclidean distance between x and pᵢ does not ensure that x is semantically associated with that reference point or even connected to that reference point on the surface. The merge module 202 replaces the Euclidean distance with the geodesic distance d_{M}(x,pᵢ)= [symbol] (γ). The Voronoi cell of a seed, defined by the set of the query point where that seed is the closest seed to the query point, is the region where the merge module 202 computes the UV coordinates based on (pᵢ,e₁ᵢ,e₂ᵢ). Using the geodesic closest seed implies partitioning the surface with the geodesic Voronoi cells, which are connected. As a result, the merge module 202 generates coherent parameterization on implicit surfaces and can use much fewer seeds than conventional techniques.

Because the geodesic distance is longer than the Euclidean distance, the merge module 202 can use the Euclidean distance to speed up the subroutine in finding the geodesic-nearest seed. The merge module 202 first finds the closest seeds with respect to the Euclidean distance to the query point, sorted by ascending order. Starting with the Euclidean closest seed, the merge module 202 utilizes procedure 500 to compute the geodesic distance between the query point and each seed. If a particular seed has a larger Euclidean distance than the current minimal geodesic distance, that seed cannot be closer to the query point than the current best seed and the merge module 202 can terminate the iteration early with few calls to procedure 500.

The merge module 202 then determines whether blending is needed (block 808). This determination is based on factors such as the number of nearby seeds and their distances to the query point. If blending is not needed (e.g., a “no” determination at block 808), the procedure 800 ends (block 816). If blending is needed (e.g., a “yes” determination at block 808), the merge module 202 determines edge weights (block 810).

To generate a global or semi-global parameterization, the system 200 interpolates the UV fields from different seeds. For example, the merge module 202 uses the Voronoi diagram of the seeds to guide the interpolation. To keep the evaluation fully point-wise, real-time, and implicit by nature, the merge module 202 uses kernel-based techniques (e.g., using the distance to each seed to calculate the interpolation weight). However, interpolating UV fields is more involved than interpolating fixed data. Since each parameterization is centered around a UV coordinate system at its seed pᵢ, simply taking a weighted sum of different UV fields results in incoherent texture. To express each UV field involved in the interpolation in a common coordinate system, the merge module 202 assign each seed with an offset location uᵢ, or an UV offset 214, in a mutually agreeable manner.

FIG. 7 depicts an example 700 of combining multiple UV fields for an implicit surface 702. The merge module uses UV coordinates (e.g., a first UV coordinate system 704, a second UV coordinate system 706, and a third UV coordinate system 708) from adjacent seeds to combine multiple UV fields. For example, the merge module takes weighted averages of coordinates at a query point 710 from the adjacent seeds. Because each log map (e.g., a first log map 712, a second log map 714, and a third log map 716) is expressed in its own referential, the merge module 202 first assigns each seed an offset coordinate uᵢ in a common UV space 718. In this common coordinate system, the merge module 202 can blend the coordinates at the interfaces between the seeds using compact support interpolation to generate a blended UV field 720.

The merge module 202 builds a graph (V,E) where the vertices are the seeds location

$$V = {\{ {p}_{i} \}}_{i = 1}^{n}$$

and an edge is included E_{i,j}∈E if the user selects pᵢ and pⱼ for merging. Each edge is weighted by the geodesic distance. The merge module 202 also attaches the UV offset uᵢ to each seed into tuples, which are package with the weighted graph into an Atlas data structure A sent to a GPU or other processing device for rendering the textured surface.

These weights are calculated based on the geodesic distances between the query point and the relevant seeds. The edge weights assist the blending process by controlling the influence of each seed's parameterization on the final result. The weighting function 216 used in the merging process has specific properties that contribute to the quality of the final parameterization. It is non-zero within a finite region around each reference point, which localizes its influence and prevents unwanted interactions between distant patches. Additionally, the weighting function 216 is continuous, which ensures that the resulting parameterization does not have abrupt changes or discontinuities.

To avoid frequent calls to procedure 500, the merge module 202 blends at the Voronoi frontier (e.g., the boundary of Voronoi cells) between two seeds. The following equation provides an approximation of the geodesic distance to the geodesic Voronoi frontier:

$${d}_{{V}_{i j}} ( x ) \approx \frac{{{d}_{M} ( x , {p}_{i} )}^{2} - {{d}_{M} ( x , {p}_{j} )}^{2}}{2 {{d}_{M} ( {p}_{j} , {p}_{i} )}^{2}} \qquad ( 29 )$$

The merge module 202 uses this approximated distance as a weight function to blend the UV fields from the two seeds. Given a blending width 2σ>0, the merge module 202 defines the weight using a smooth blending function ω:

$${ω}_{i , j} ( x ) = \{ \begin{matrix}1 , {d}_{{V}_{ij}} ( x ) < - σ \\ 0 , σ < {d}_{{V}_{ij}} ( x ) \\ ω ( \frac{1}{2} - \frac{{d}_{{V}_{ij}} ( x )}{2 σ} ) , - σ \leq {d}_{{V}_{ij}} ( x ) \leq σ\end{matrix} \qquad ( 30 )$$

In one implementation, the merge module 202 uses ω(t)=3t²−2t³, but another smooth function with ω(0)=0 and ω(1)=1 can work. In this implementation, the blending width is set to

$$σ = \frac{1}{3} {min}_{{e}_{i j} ∈ E} {d}_{M} ( {p}_{i} , {p}_{j} )$$

for each seed pair.

If a query point falls in the blending area of more than two seeds, the merge module 202 uses a weight for each of the relevant seeds and combines weights from multiple seeds (block 812). The merge module 202 uses a continuous formula that depends on distances to nearby seeds selected for blending:

$${ω}_{i} ( x ) = {min}_{j : {e}_{i j} ∈ E} {ω}_{i , j} ( x ) \qquad ( 31 )$$

To implement procedure 800 efficiently in shaders, if pᵢ is the closest seed to the query point, the merge module 202 skips Equation 31 for other seeds pⱼ and uses the following approximation:

ωⱼ(x)≈ω_{j,i}(x)=1−ω_{i,j}(x) (32)

This assumption makes the evaluation linear in the number of seeds to blend and prevents caching.

If a particular seed pᵢ is the closest seed to the query point and if ω_{i,j}(x)=1 for a neighbor seed pⱼ, then the merge module 202 does not compute the log map for that neighbor seed because it will not influence the final UV field at the query point. If the following condition is met, then the merge module 202 saves a call to procedure 500:

d_{M}(x,pᵢ)²+2σd_{M}(pᵢ,pⱼ)<∥x−pⱼ∥² (33)

Because two seeds with inconsistent frames can cause the merged parameterization to have severe distortion, the merge module 202 optimizes the frame placement and UV offsets together to minimize distortion. In one implementation, system 200 allows users to specify the position of the seeds together with the blending graph that indicates which seeds to blend.

The distortion of a parameterization is understood as a measurement of how it differs from an isometry (e.g., a locally rigid map). For example, the merge module 202 measures how the parameterized surface behaves differently from the UV plane. By introducing optimization variables tᵢ for the frame vector e₁ at each seed, the merge module 202 selects the optimal frames by minimizing a Dirichlet energy on the blending graph A, weighted by the inverse squared geodesic distance to favor interactions with closest neighbors to penalize distortions:

$${E}_{frame} ( {\{ {t}_{i} \}}_{i = 1}^{n} ) = {\sum }_{{e}_{i j} ∈ E} \frac{{‖ {R}_{i \to j} {t}_{i} - {t}_{j} ‖}^{2}}{{{d}_{M} ( {p}_{i} , {p}_{j} )}^{2}} \qquad ( 34 )$$

If the surface is a flat plane, the global minimizer of the energy is a constant field tᵢ=t, i=1, . . . , n, and E_{frame}=0. Once the optimal frames are computed, the merge module 202 sets e₁; by projecting tᵢ to Tₚ_{ᵢ}M and normalizing it. When the surface is curved, the optimal frame field changes as little as possible between two neighboring seeds.

Once the frames are computed, the merge module uses procedure 500 to compute the UV coordinates in reference to each neighboring seed that is to be blended (block 814). If the surface is flat, the UV offsets are trivial. The merge module 202 selects the UV offsets, scaling, and/or rotations that minimize deviation from the following equation:

$${E}_{offset} ( {\{ {u}_{i} \}}_{i = 1}^{n} ) = {\sum }_{{e}_{i j} ∈ E} \frac{{‖ {u}_{i} - {u}_{j} - {Log}_{{p}_{j}} ( {p}_{i} ) ‖}^{2}}{{{d}_{M} ( {p}_{i} , {p}_{j} )}^{2}} \qquad ( 35 )$$

The UV offset is fixed u₀=(0,0) for one seed p₀ to remove redundant degrees of freedom.

Both energies are quadratic, and the merge module 202 can minimize them by solving a linear system. The corresponding matrices are standard graph Laplacians, except that the frame energy matrix is defined by blocks where the parallel transport matrices are stored in the cross terms, similar to the discrete connection Laplacians. Because the linear systems are proportional in size to the number of seeds in the blending graph (e.g., generally a small number), the merge module 202 can instantaneously solve these systems to update the frames and UV offsets if the user changes the implicit surface.

Parallel transport refers to the way a tangent vector evolves when transported along a curve y from one point of the surface to another. The parameterization module 126 builds the mapping from the tangent plane of the seed TₚM to one of the query points TₓM. FIG. 4 illustrates the accumulation process 400 of the parameterization module 126 of FIGS. 1 and 2. The parameterization module 126 can discretize parallel transport along the geodesic curve. The product of each rotation matrix is stored in one rotation matrix.

On a classical triangular mesh, the smallest rotation matrix between two neighboring faces Fᵢ and Fⱼ gives a coherent discretization of the parallel transport between T_{F}_{ᵢ}M and T_{F}_{ⱼ}M. This rotation is the same as the one that rotates the face normal nᵢ to nⱼ along the dihedral angle, given by the following formula:

$${R}_{{n}_{i} , {n}_{j}} = {I}_{3} + J + \frac{1}{1 + 〈 {n}_{i} , {n}_{j} 〉} {J}^{2} , \qquad ( 36 )$$

where J is the skew-symmetric matrix such that Ju=(nᵢ×nᵢ)×u for each u∈ [symbol] . The parameterization module 126 takes inspiration from this formula and builds the parallel transport matrix from reference point p to query point x by accumulating the rotation at each iteration between xᵢ and xᵢ₊₁:

$${R}_{{T}_{p} M \to {T}_{x} M} = {\prod }_{i = 1}^{n - 1} {R}_{n ( {x}_{i + 1} ) , n ( {x}_{i} )} . \qquad ( 37 )$$

As the system 200 processes the implicit surface 128 and merges multiple parameterization patches, it generates a representation of the merged patches. This structure allows efficient access to the parameterization at different scales and resolutions, which is particularly useful for applications using level-of-detail rendering or multi-resolution analysis. To improve performance in subsequent operations, the system 200 caches a geodesic distance associated with the computed geodesic paths and UV coordinates in a spatial data structure. This caching mechanism accelerates queries for nearby points on the implicit surface 128, as the system can quickly retrieve pre-computed values instead of recalculating them for each query.

The output 218 of the system 200 is a semi-global parameterization 220 of the implicit surface 128. This semi-global parameterization 220 provides a comprehensive 2D coordinate system that covers the surface of the 3D object while respecting its geometry and topology. The semi-global parameterization 220 enables various applications in computer graphics and modeling.

For example, the semi-global parameterization 220 enables efficient warping of implicit surfaces, allowing users to perform complex deformations and transformations of 3D objects. By applying the generated UV coordinates to modify the underlying scalar field, designers can achieve smooth and continuous warping effects that preserve the implicit nature of the surface. When rendering an implicit shape deformed by a warping operator, the system 200 can compute the UV coordinates on the rest pose and transfer the texture to the deformed pose to allow for global and local deformations, providing fine-grained control over the shape manipulation process. The ability to perform real-time warping operations while maintaining the implicit surface representation allows for dynamic and interactive shape manipulation, which may benefit digital sculpting and virtual reality modeling.

The semi-global parameterization 220 also facilitates the application of color textures to implicit surfaces. By mapping 2D texture images onto the UV coordinate system, designers can add detailed color information to the surface without explicit mesh representations. This color-texturing approach allows for high-resolution texturing that conforms to the geometry of the implicit surface, preserves fine details, and ensures proper alignment across patch boundaries.

The system 200 also enables normal to be applied to the semi-global parameterizations 220. Normal maps are textures that include three channels with the 3D coordinates of the material's normal vector at each point of the texture. Accordingly, normal maps capture sub-resolution details that may change how light reflects off the surface. Because normal are vectors, they are stored in coordinates with a fixed basis. At a given location on a surface with the local tangent vector, bi-tangent vector, and normal vector, the normal map augments the rendering normal. On implicit surfaces, the tangent frame and normal at a particular seed are a part of the Atlas data structure. As a result, the system 200 transports this frame from the nearest seed to the query point to obtain the rendering normal.

The application of normal maps to implicit surfaces allows for the addition of fine surface details without increasing the complexity of the underlying geometry. By mapping normal information to the generated UV coordinate system, designers can simulate intricate surface features such as bumps, scratches, or wrinkles. This approach preserves the smooth, continuous nature of the implicit surface while providing the visual richness typically associated with high-polygon models.

Similarly, the system 200 facilitates applying displacement maps to implicit surfaces to add geometric details that modify the actual surface shape. By using the generated UV coordinates to guide the displacement of points on the implicit surface, designers can create complex surface features such as scales, ridges, or porous structures.

One significant application is the ability to apply texture maps to the implicit surface 128 using the generated UV coordinates. These texture maps can include color textures, normal maps, shell maps, or displacement maps, allowing for the addition of detailed surface properties to the 3D object.

The real-time nature of the system 200 makes it particularly suitable for interactive applications where the implicit surface 128 might undergo deformations or topological changes. The system can quickly update the parameterization to reflect these changes, maintaining a consistent mapping of textures and other surface properties.

### Example Parameterization Procedure

The following discussion describes implementable techniques utilizing the previously described systems and devices. Aspects of each procedure are implementable in hardware, firmware, software, or a combination thereof. The procedures are shown as blocks that specify operations performed by one or more devices and are not necessarily limited to the orders shown for performing the operations by the respective blocks. In portions of the following discussion, reference is made to FIGS. 1-8.

FIG. 9 depicts a procedure in an example implementation of real-time parameterization of implicit surfaces. To begin, an implicit surface representing a 3D object is received (block 902). For example, a processing device receives an implicit surface defined by a scalar field in 3D space, such as a signed distance function or a level set function.

The parameterization module 126 then approximates a geodesic path between a query point and a reference point on the implicit surface (block 904). For example, the processing device projects a gradient of Euclidean distance between the query point and the reference point onto a tangent plane of the implicit surface and moves along the surface using a second-order approximation of the surface.

During the path approximation, the parameterization module 126 monitors for sharp features on the implicit surface by testing for a normal discontinuity along the geodesic path. Sharp features are detected by comparing adjacent normal vectors and determining when an angle between the adjacent normal vectors exceeds a predefined threshold value. In some scenarios, the parameterization patch is at least partially bounded by one or more sharp features or a user-specified maximum radius.

The parameterization module 126 then generates a parameterization patch on the implicit surface using the geodesic path (block 906). The parameterization patch provides a localized 2D coordinate system on a portion of the surface of the 3D object. For example, the parameterization module 126 generates a local coordinate system around the reference point and/or the query point.

In some implementations, multiple local parameterization patches are generated on the implicit surface using multiple reference points. The patches are merged into a larger, spatially coherent region conforming to the geometry of the implicit surface by assigning UV offsets, scaling, and/or rotations to each reference point and blending the UV coordinates from adjacent patches using a weighting function based on geodesic distances. The weighting function is designed to be non-zero within a finite region around each reference point and continuous. The merged patches include a common 2D coordinate system to provide a semi-global parameterization of the implicit surface.

The parameterization module 126 generates UV coordinates for the query point based on the approximated geodesic path (block 908). For example, a processing device computes the length of the geodesic path and the angle with a reference direction to determine the UV coordinates. In some implementations, a texture map is applied to the implicit surface using the generated UV coordinates. The texture map includes a color texture, a normal map, or a displacement map.

The geodesic distance associated with the geodesic path and the UV coordinates may be cached in a spatial data structure to accelerate subsequent queries for nearby points on the implicit surface. In one implementation, procedure 900 is implemented in shaders executed on a GPU to enable real-time performance and dynamic updating of the parameterization in response to deformations or topological changes of the implicit surface.

### Example System and Device

FIG. 10 illustrates an example system 1000 that includes an example computing device 1002 that is representative of one or more computing systems and/or devices that implement the various techniques described herein. This is illustrated by including the 3D modeling service 120 with the parameterization module 126. The computing device 1002 is configurable, for example, as a server of a service provider, a device associated with a client (e.g., a client device), an on-chip system, and/or any other suitable computing device or computing system.

The example computing device 1002, as illustrated, includes a processing system 1004, one or more computer-readable media 1006, and one or more I/O interface 1008 that are communicatively coupled to one another. Although not shown, the computing device 1002 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing system 1004 is representative of the functionality to perform one or more operations using hardware. Accordingly, the processing system 1004 is illustrated as including hardware element 1010 that is configurable as processors, functional blocks, and so forth. This includes implementation in hardware as an application-specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 1006 is illustrated as including memory/storage 1012. The memory/storage 1012 represents memory/storage capacity associated with one or more computer-readable media. The memory/storage 1012 includes volatile media (such as random-access memory (RAM)) and/or nonvolatile media (such as read-only memory (ROM), Flash memory, optical disks, magnetic disks, and so forth). The memory/storage 1012 includes fixed media (e.g., RAM, ROM, a fixed hard drive, and so on) and removable media (e.g., Flash memory, a removable hard drive, an optical disc, and so forth). The computer-readable media 1006 is configurable in various ways, as described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 1002, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module executable by the computing device 1002 as software is achieved at least partially in hardware, e.g., through computer-readable storage media and/or hardware elements 1010 of the processing system 1004. The instructions and/or functions are executable/operable by one or more articles of manufacture (for example, one or more computing devices and/or processing systems 1004) to implement techniques, modules, and examples described herein.

The techniques described herein are supported by various configurations of the computing device 1002 and are not limited to the specific examples of the techniques described herein. This functionality is also implementable through a distributed system, such as over a “cloud” 1014 via a platform 1016 as described below.

Cloud 1014 includes and/or represents a platform 1016 for resources 1018. Platform 1016 abstracts the underlying functionality of hardware (e.g., servers) and software resources of the cloud 1014. Resources 1018 include applications and/or data that can be utilized when computer processing is executed on remote servers from the computing device 1002. Resources 1018 can also include services provided over the Internet and/or through a subscriber network, such as a cellular or Wi-Fi network.

Platform 1016 abstracts resources and functions to connect computing device 1002 with other computing devices. The platform 1016 also serves to abstract scaling of resources to provide a corresponding level of scale to encountered demand for the resources 1018 implemented via the platform 1016. Accordingly, in an interconnected device embodiment, the implementation of functionality described herein is distributable throughout the system 1000. For example, the functionality is implementable in part on the computing device 1002 and via the platform 1016, which abstracts the functionality of the cloud 1014.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, an implicit surface representing a three-dimensional (3D) object;
approximating, by the processing device, a geodesic path between a query point and a reference point on the implicit surface;
generating, by the processing device and using the geodesic path on the implicit surface, a parameterization patch on the implicit surface, the parameterization patch providing a localized two-dimensional (2D) coordinate system on a portion of a surface of the 3D object; and
generating, by the processing device, UV coordinates for the query point based on the geodesic path.

2. The method of claim 1, wherein approximating the geodesic path comprises, for a fixed number of iterations:
projecting a gradient of Euclidean distance between the query point and the reference point onto a tangent plane of the implicit surface; and
moving along the surface from the query point toward the reference point using a second-order approximation of the surface.

3. The method of claim 2 further comprising:
detecting sharp features on the implicit surface by testing for a normal discontinuity along the geodesic path, wherein the normal discontinuity is determined by comparing adjacent normal vectors and determining when an angle between the adjacent normal vectors exceeds a predefined threshold value.

4. The method of claim 3, wherein the parameterization patch is at least partially bounded by one or more sharp features or a user-specified maximum radius.

5. The method of claim 1 further comprising:
generating multiple local parameterization patches on the implicit surface using multiple reference points; and
merging adjacent parameterization patches into a larger spatially coherent region conforming to a geometry of the implicit surface.

6. The method of claim 5, wherein merging the adjacent parameterization patches comprises:
assigning UV offsets to each reference point; and
blending the UV coordinates from adjacent patches using a weighting function based on geodesic distances.

7. The method of claim 6, wherein the weighting function is non-zero within a finite region around each reference point and continuous.

8. The method of claim 1 further comprising:
applying a texture map to the implicit surface using the UV coordinates, the texture map including at least one of a color texture, a normal map, a shell map, or a displacement map.

9. The method of claim 1 further comprising:
performing parallel transport of tangent vectors along the geodesic path to enable an application of normal maps on the implicit surface.

10. The method of claim 1, wherein:
the processing device comprises a graphics processing unit; and
the method is implemented in shaders executed on the graphics processing unit.

11. The method of claim 1 further comprising:
caching a geodesic distance associated with the geodesic path and the UV coordinates in a spatial data structure to accelerate subsequent queries for nearby points on the implicit surface.

12. A system comprising:
a memory component; and
one or more processing devices coupled to the memory component, the one or more processing devices to perform operations comprising:
receive an implicit surface representing a three-dimensional (3D) object;
generate, using respective reference points, multiple local parameterization patches on the implicit surface, each parameterization patch providing a localized two-dimensional (2D) coordinate system on a portion of a surface of the 3D object; and
merge the multiple local parameterization patches into a common 2D coordinate system to create a semi-global parameterization of the implicit surface.

13. The system of claim 12, wherein generating each local parameterization patch comprises adaptively adjusting a size and shape of the local parameterization patch based on a local surface curvature of the implicit surface.

14. The system of claim 12, wherein the one or more processing devices are further configured to dynamically update the multiple local parameterization patches in real-time in response to deformations or topological changes of the implicit surface.

15. The system of claim 12, wherein the one or more processing devices are further configured to generate a representation of the merged multiple local parameterization patches.

16. The system of claim 12, wherein the one or more processing devices are configured to merge adjacent parameterization patches by:
assigning UV offsets to each reference point; and
blending UV coordinates from adjacent patches using a weighting function based on geodesic distances.

17. The system of claim 12, wherein the one or more processing devices are further configured to apply a texture map to the implicit surface using the common 2D coordinate system, the texture map including at least one of a color texture, a normal map, or a displacement map.

18. A non-transitory computer-readable storage medium storing executable instructions, which when executed by a processing device, cause the processing device to perform operations comprising:
receiving an implicit surface defined by a scalar field in three-dimensional (3D) space and representing a 3D object;
generating, using a reference point on the implicit surface, a parameterization of the implicit surface, the parameterization providing a localized two-dimensional (2D) coordinate system on a surface of the 3D object; and
applying a two-dimensional texture to the implicit surface using the parameterization.

19. The non-transitory computer-readable storage medium of claim 18, wherein generating the parameterization comprises generating multiple local parameterization patches on the implicit surface using respective reference points and merging the multiple local parameterization patches into a common coordinate system.

20. The non-transitory computer-readable storage medium of claim 18, wherein:
the two-dimensional texture comprises at least one of a color texture, a normal map, a shell map, or a displacement map; and
the executable instructions, which when executed by the processing device, further cause the processing device to dynamically update the parameterization in real-time in response to deformations or topological changes of the implicit surface.
